(19) United States
(12) Patent Application Publication
(10) Pub. No.: US 2013/0155120 A1
(43) Pub. Date: Jun. 20, 2013

(54) Color Adjustment Device, Method for Adjusting Color, and Display for the Same

(71) Applicant: Chih-tsung Kang, Shenzhen (CN)

(72) Inventor: Chih-tsung Kang, Shenzhen (CN)

(73) Assignee: SHENZHEN CHINA STAR OPTOELECTRONICS TECHNOLOGY CO., LTD., Shenzhen (CN)

(21) Appl. No.: 13/380,891

(22) PCT Filed: Dec. 16, 2011
(86) PCT No.: PCT/CN2011/084136

§ 371 Date: Dec. 26, 2011

(30) Foreign Application Priority Data
Dec. 15, 2011 (CN) 201110420014.5

(51) Int. Cl. G09G 5/10

(52) U.S. Cl. 345/690

(57) ABSTRACT

A method for adjusting color measures tristimulus values of white, red, green, and blue at all grayscales performed on a LCD panel, and then converts a white-measured stimulus set (WX₂₅₅, WY₂₅₅, WZ₂₅₅) of measured stimulus sets (WXₚ, WYₚ, WZₚ) into a target luminance value WYₚ, a target chromatic values W_{Xp}, W_{Yp} of each grayscale, and subsequently converts the target luminance value WYₚ, the target chromatic values W_{Xp}, W_{Yp} into target stimulus sets, and finally calculates a set of ratios performing as white at each grayscale on basis of each target stimulus set (WX′ₚ, WY′ₚ, WZ′ₚ) and sets of tristimulus values at all grayscales. Accordingly, the corresponding ratios of three primary colors performing as white at each grayscale are calculated based on the target luminance value WYₚ, target chromatic values W_{Xp} and W_{Yp}. As a result, the calculated RGB ratios are more precise.

### BACKGROUND OF THE INVENTION

1. Field of the Invention

The present invention relates to a display, and more particularly to a color adjustment device, a method for adjusting color, and a display for the same.

2. Description of the Prior Art

Based on a conventional image processing technology, a display area on a LCD panel is divided into multiple pixels, each of which comprises sub-pixels of displaying red, green and blue. Because all colors of visible light can be made by mixture of red, green and blue light, a required color shown in a pixel can be constructed by controlling luminance value of the red, green and blue sub-pixels.

To describe color more appropriately, the International Commission on Illumination, hereinafter referred to as the CIE, proposed the CIE 1931 XYZ color space, in which regard red, green and blue as three primary colors, and all other colors can be generated by mixture of the three primary colors. Two light sources, made up of different mixtures of various wavelengths, may appear to be the same color; this effect is called metamerism. Two light sources have the same apparent color to an observer when they have the same tristimulus values, no matter what spectral distributions of light were used to produce them. In this case, the two light sources have the same tristimulus values X, Y and Z which refer to proportions of the three primary colors. The CIE 1931 XYZ Space usually shows as the CIE 1931 chromaticity diagram, of which three parameters Y, x, y, where Y refers to luminance value, that is the stimulus value Y, while x and y refer to chromaticity values. In this case, x=X/(X+Y+Z), y=Y/(X+Y+Z), z=Z/(X+Y+Z). Because x+y+z=1, z can be expressed in x and y.

When LCD panels display, color derivation probably occurs even if they are showing the white color at the same grayscale. In order to attain accuracy and consistency of colors on the LCD, it is necessary to perform white balance for each LCD. The method of white balance is as followed: At first, make pixels of the LCD show as white at all grayscales, and then adjust gain values of the strength of red, green and blue so that the chromatic values and the luminance value of the white performed on the LCD approaches a set of chromatic values and luminance value of a target white, that is, the white performed on the LCD is adjusted within a certain range of color temperature and color derivation.

In process of the traditional white balance, two criteria are needed. One criterion is that a luminance value L of the white point in relation to a grayscale n must be satisfied as: L∝(n/255)^{2.2}. The other criterion is that whites performed at all grayscales must be maintained in the same hue. Referring to FIG. 1, FIG. 1 shows a graph of relation between white and chromatic value in grayscale 0 to 255, according to the CIE 1931 XYZ color space, where Wxₙ and Wyₙ refer to the chromatic value x, y required to perform as white at grayscale n (n=0, 1, 2, 3 . . . 254,255). FIG. 1 shows that the chromatic values x, y of various white at different grayscales in the CIE1931 XYZ color space. For instance, at the grayscale 50, when Wx₅₀=0.285 and Wy₅₀=0.295, the pixel performs as white. In other words, by adjusting the grayscale applied to the RGB sub-pixels of the pixel so as to the chromatic value of RGB sub-pixels meet Wx₅₀=0.285 and Wy₅₀=0.295, the pixel is performing as white. Take FIG. 1 for example, at higher grayscale, such as 40 to 255, the ratio of the chromatic values x and y is a constant, that is, Wx₂₅₅=Wxₙ=0.285 and Wy₂₅₅=Wy₅₀=0.295, n=40, 41, . . . , 255, while at lower grayscale, such as 1 to 40, the ratios of the chromatic values x and y are diverse.

The luminance value of green has the strongest effect on the luminance value of white, so in traditional white balance method, it is general to find out the voltage applied to the green sub-pixel on the basis of the relation between the grayscale and the luminance of green. After then, calculate voltages applied to the red sub-pixel and blue sub-pixel on the condition of keeping the chromatic values of white unchanged. In this method, it is to find the corresponding grayscale of the green sub-pixel on the ground of the relation between the grayscale and the luminance of green when the LCD performs as white at each grayscale. But, in the process of matching chromatic values, the impact of the green sub-pixel on the stimulus values X and Z is ignored. The corresponding grayscales of the red and the blue sub-pixels calculated on the basis of the white tristimulus values consequently ignores their impact on the luminance values of all white grayscales, which has negative effects on the accuracy of white balance in total.

### SUMMARY OF THE INVENTION

Accordingly, the present invention has been made to propose a color adjustment device, a method for adjusting color, and a display device for the same, which provides a more precise set of ratios of red, green and blue in the process of white balance.

According to the present invention, a method of adjusting color comprises the steps of: (a) measuring a plurality of measured sets (WXₚ, WYₚ, WZₚ), (RX_{M}, RY_{M}, RZ_{M}), (GX_{L}, GY_{L}, GZ_{L}), and (BX_{N}, BY_{N}, BZ_{N}) performing respectively as white, red, green and blue at all grayscales on a LCD panel, where p, M, L, N=0, 1, 2, . . . , 255; (b) converting a predetermined white-measured set (WX₂₅₅, WY₂₅₅, WZ₂₅₅) from the plurality of measured stimulus sets (WXₚ, WYₚ, WZₚ) into a plurality of target chromatic sets comprising a target luminance value WYₚ, a first target chromatic value W_{Xp}, and a second target chromatic value W_{Yp} of each of white grayscales, where WYₚ=WY₂₅₅×(p/255)^{2.2}, W_{Xp}=WX₂₅₅/(WX₂₅₅+WY₂₅₅±WZ₂₅₅) W_{Yp}=WY₂₅₅/(WX₂₅₅+WY₂₅₅±WZ₂₅₅), p=0, 1, 2, . . . , 255; (c) converting each of the target chromatic sets into a plurality of white target stimulus sets, each white grayscale corresponding to a target stimulus set and each target stimulus set comprising three target stimulus values WX′ₚ, WY′ₚ, WZ′ₚ, where WY′ₚ=WY₂₅₅×(p/255)^{2.2}, WX′ₚ=W_{X255}×(WY′ₚ/W_{Y255}), WZ′ₚ=(1−W_{Xp}−W_{Yp})×(WY′ₚ/W_{Yp}), p=0, 1, 2, . . . , 255; and (d) calculating each set of RGB ratios for each white grayscale, based on the corresponding white target stimulus set (WX′ₚ, WY′ₚ, WZ′ₚ) and the corresponding measured stimulus set (WXₚ, WYₚ, WZₚ) at the corresponding grayscale.

In one aspect of the present invention, the method further comprises: before the LCD panel showing a predetermined white grayscale, adjusting RGB ratios of a predetermined white grayscale according to the RGB ratios of the target stimulus set at the predetermined white grayscale.

In another aspect of the present invention, the LCD panel comprises a plurality of pixels. Each pixel comprises a plurality of sub-pixels for displaying three primary colors, red, green and blue. The method further comprises: based on the RGB ratios of the target stimulus set at the predetermined white grayscale, adjusting driving voltages applied to the plurality of sub-pixels of each pixel.

In yet another aspect of the present invention, the step (d) further comprises: calculating a least-square solution of the target stimulus sets (WX′ₚ, WY′ₚ, WZ′ₚ) of each white target stimulus set associated with the corresponding measured stimulus sets (WXₚ, WYₚ, WZₚ), in order to obtain the RGB ratios corresponding to each white grayscale.

According to the present invention, a color adjusting device comprises: a measuring unit for measuring a measured stimulus set (WXₚ, WYₚ, WZₚ/RX_{M}, RY_{M}, RZ_{M}/GX_{L}, GY_{L}, GZ_{L}/BX_{N}, BY_{N}, BZ_{N}) performing as white, red, green and blue at all grayscales on a LCD panel, where p, M, L, N=0, 1, 2, . . . , 255; a first conversion unit, connected to the measuring unit, for converting a predetermined white-measured stimulus set (WX₂₅₅, WY₂₅₅, WZ₂₅₅) of the plurality of measured stimulus sets (WXₚ, WYₚ, WZₚ) into a target chromatic set comprising a target luminance value WYₚ, a first target chromatic value W_{Xp}, and a second target chromatic value W_{Yp} of each of white grayscales, where WYₚ=WY₂₅₅×(p/255)^{2.2}, W_{Xp}=WX₂₅₅/(WX₂₅₅+WY₂₅₅±WZ₂₅₅) W_{Yp}=WY₂₅₅/(WX₂₅₅+WY₂₅₅+WZ₂₅₅), p=0, 1, 2, . . . , 255; a second conversion unit, connected to the first conversion unit, for converting the target chromatic set of each white grayscale into a plurality of white target stimulus sets (WX′ₚ, WY′ₚ, WZ′ₚ), each white grayscale corresponding to a target stimulus set and each target stimulus set comprising three target stimulus values WX′ₚ, WY′ₚ, WZ′ₚ, where WY′ₚ=WY₂₅₅×(p/255)^{2.2}, WX′ₚ=W_{X255}×(WY′ₚ/W_{Y255}), WZ′ₚ=(1−W_{Xp}−W_{Yp})×(WY′ₚ/W_{Yp}), p=0, 1, 2, . . . , 255; and a calculation unit, connected to the second conversion unit, for calculating each set of RGB ratios for each white grayscale, based on the corresponding white target stimulus set (WX′ₚ, WY′ₚ, WZ′ₚ) and the measured stimulus set (WXₚ, WYₚ, WZₚ) of the corresponding grayscale.

In one aspect of the present invention, the color adjusting device further comprises a storage unit for storing as a lookup table of all the RGB ratios corresponding to the white target stimulus sets produced by the calculation unit.

In another aspect of the present invention, the color adjusting device further comprises an adjusting unit, connected to the storage unit, for adjusting, before the LCD panel showing a predetermined white grayscale, the RGB ratios of the predetermined white grayscale according to the RGB ratios of the target stimulus set at the predetermined white grayscale.

In yet another aspect of the present invention, the calculation unit calculates a least-square solution of the stimulus sets (WX′ₚ, WY′ₚ, WZ′ₚ) of each white target stimulus set associated with the corresponding measured stimulus sets (WXₚ, WYₚ, WZₚ), in order to obtain the RGB ratios corresponding to each white grayscale.

According to the present, a display comprises a liquid crystal display (LCD) panel and a color adjustment device. The LCD panel comprises a plurality of pixels for displaying an image. Each pixel comprises a plurality of sub-pixels. The color adjustment device comprises: a measuring unit for measuring a measured stimulus set (WXₚ, WYₚ, WZₚ/RX_{M}, RY_{M}, RZ_{M}/GX_{L}, GY_{L}, GZ_{L}/BX_{N}, BY_{N}, BZ_{N}) performing as white, red, green and blue at all grayscales on a LCD panel, where p, M, L, N=0, 1, 2, . . . , 255; a first conversion unit, connected to the measuring unit, for converting a predetermined white-measured stimulus set (WX₂₅₅, WY₂₅₅, WZ₂₅₅) of the plurality of measured stimulus sets (WXₚ, WYₚ, WZₚ) into a target chromatic set comprising a target luminance value WYₚ, a first target chromatic value W_{Xp}, and a second target chromatic value W_{Yp} of each of white grayscales, where WYₚ=WY₂₅₅×(p/255)^{2.2}, W_{Xp}=WX₂₅₅/(WX₂₅₅+WY₂₅₅+WZ₂₅₅), W_{Yp}=WY₂₅₅/(WX₂₅₅+WY₂₅₅+WZ₂₅₅), p=0, 1, 2, . . . , 255; a second conversion unit, connected to the first conversion unit, for converting the target chromatic set of each white grayscale into a plurality of white target stimulus sets (WX′ₚ, WY′ₚ, WZ′ₚ), each white grayscale corresponding to a target stimulus set and each target stimulus set comprising three target stimulus values WX′ₚ, WY′ₚ, WZ′ₚ, where WY′ₚ=WY₂₅₅×(p/255)^{2.2}, WX′ₚ=W_{X255}×(WY′ₚ/W_{Y255}), WZ′ₚ=(1−W_{Xp}−W_{Yp})×(WY′ₚ/W_{Yp}), p=0, 1, 2, . . . , 255; and a calculation unit, connected to the second conversion unit, for calculating each set of RGB ratios for each white grayscale, based on the corresponding white target stimulus set (WX′ₚ, WY′ₚ, WZ′ₚ) and the measured stimulus set (WXₚ, WYₚ, WZₚ) of the corresponding grayscale.

In one aspect of the present invention, the color adjusting device further comprises a storage unit for storing as a lookup table of all the RGB ratios corresponding to the white target stimulus sets produced by the calculation unit.

In another aspect of the present invention, the color adjusting device further comprises an adjusting unit, connected to the storage unit, for adjusting, before the LCD panel showing a predetermined white grayscale, the RGB ratios of the predetermined white grayscale according to the RGB ratios of the target stimulus set at the predetermined white grayscale.

In yet another aspect of the present invention, the display further comprises a driving unit coupled to the adjusting unit for adjusting driving voltage applied to the plurality of sub-pixels of each pixel according to the RGB ratios corresponding to the set of three target stimulus values at the predetermined grayscale.

In still another aspect of the present invention, the calculation unit calculates a least-square solution of the white target stimulus set (WX′ₚ, WY′ₚ, WZ′ₚ) associated with the corresponding measured stimulus sets (WXₚ, WYₚ, WZₚ), in order to obtain the RGB ratios corresponding to each white grayscale.

In contrast to the prior art, the color adjustment device, the method for adjusting color and the display for the same according to the present invention at first measures on a LCD panel a plurality of measured stimulus sets (WXₚ, WYₚ, WZₚ/RX_{M}, RY_{M}, RZ_{M}/GX_{L}, GY_{L}, GZ_{L}/BX_{N}, BY_{N}, BZ_{N}) of white, red, green and blue at all grayscales and then converts a predetermined white-measured stimulus set (WX₂₅₅, WY₂₅₅, WZ₂₅₅) of the multiple sets of white measured stimulus set (WXₚ, WYₚ, WZₚ) into a target luminance value WYₚ, a first target chromatic value W_{Xp}, and a second target chromatic value W_{Yp}. Subsequently, the color adjustment device, the method for adjusting color and the display according to the present invention convert the target luminance value WYₚ, the first target chromatic value W_{Xp}, and the second target chromatic value W_{Yp} at each grayscale into a plurality of target stimulus sets (WX′ₚ, WY′ₚ, WZ′ₚ) and finally calculates a set of corresponding ratios performing as white at each grayscale, based on each target stimulus set (WX′ₚ, WY′ₚ, WZ′ₚ) and multiple sets of tristimulus values of red, green and blue at all grayscales (RX_{M}, RY_{M}, RZ_{M}/GX_{L}, GY_{L}, GZ_{L}/BX_{N}, BY_{N}, BZ_{N}). Accordingly, the corresponding ratios of three primary colors performing as white at each grayscale are not decided by first determining the green ratio and then the red and blue ratios, but calculated on the ground of the determined target luminance value WYₚ, target chromatic values W_{Xp} and W_{Yp}. As a result, the calculated RGB ratios are more precise.

These and other features, aspects and advantages of the present disclosure will become understood with reference to the following description, appended claims and accompanying figures.

### BRIEF DESCRIPTION OF THE DRAWINGS

FIG. 1 shows a graph of relation between white and chromatic value in grayscale 0 to 255, according to the CIE 1931 XYZ color space.

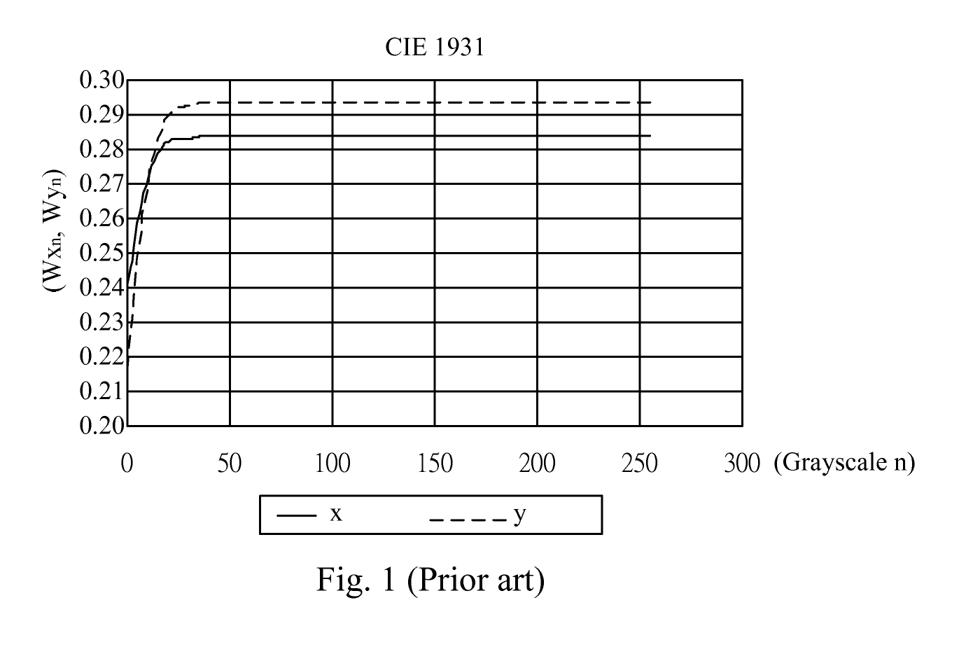

FIG. 2 depicts a schematic diagram of a preferred embodiment of a display according to the present invention.

FIG. 3 shows a block diagram of a color adjustment device.

FIG. 4 depicts a flow chart of a method for adjusting color according to the present invention.

FIG. 5 depicts a flow chart of the method, by which at the step 406 in FIG. 4, the calculation unit calculates the least square solution of the target tristimulus values and the tristimulus values.

### DETAILED DESCRIPTION OF THE PREFERRED EMBODIMENTS

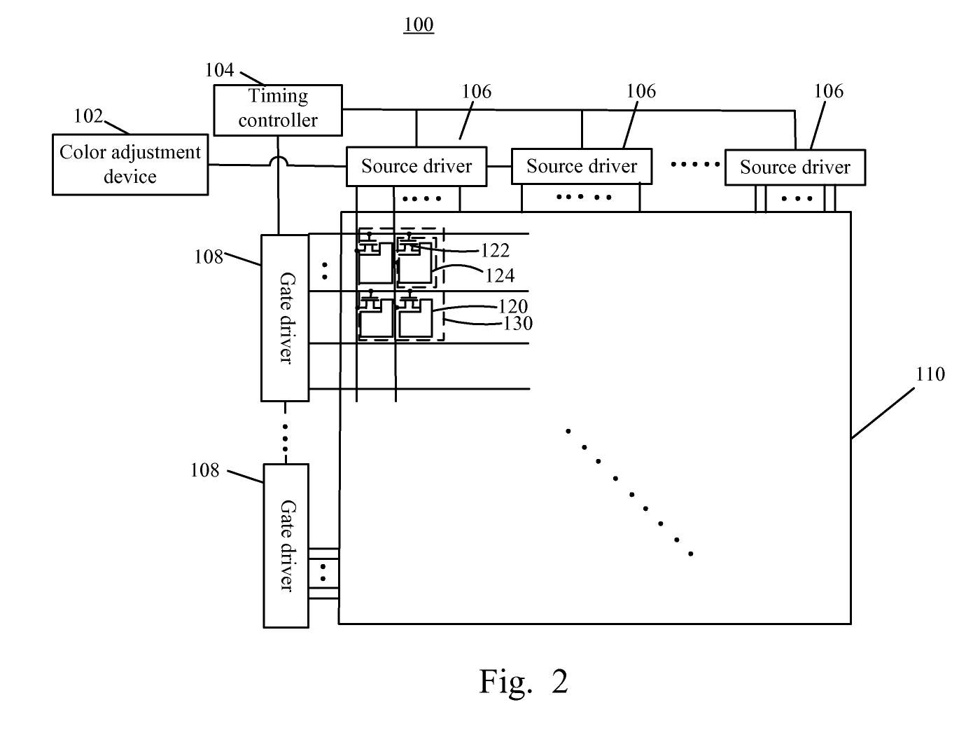

Referring to FIG. 2, FIG. 2 depicts a schematic diagram of a preferred embodiment of a display 100 according to the present invention. The display 100 can be a device of a personal computer, a notebook, a digital camera, a digital camcorder, which comprises a LCD panel 110. The display 100 further comprises a timing controller 104, source drivers 106, a gate driver 108, and a color adjustment device 102. The LCD panel 110 comprises a plurality of pixels arranged in a matrix 130. Each pixel 130 comprises at least three sub-pixels 120 for displaying red, green, and blue (hereinafter referred to as RGB). When a vertical sync signal, generated by the timing controller 104, transmitted to the gate driver 108, the gate driver 108 subsequently produces a scan pulse to the LCD panel 110. Simultaneously, the timing controller 104 generates a horizontal sync signal to the source driver 106, and then the source driver 106 outputs grayscale voltage signal to the sub-pixel 120 of the LCD panel 110. Each sub-pixel 120 comprises a pixel electrode 124 and a thin-film transistor 122. A gate, source and drain of the thin-film transistor 122 respectively electrically connects to the gate driver 108, the source driver 106 and the pixel electrode 124 of the corresponding sub-pixel 120. The gate of the thin-film transistor 122 is turned on upon receiving a scan pulse transmitted from the gate driver 108. At then, a data voltage from the source driver 106 is applied to the pixel electrode 124. Alignment of liquid crystal molecules is adjusted based on the data voltage applied on the pixel electrode 124, and thus the alignment of the liquid crystal molecules decides the light transmittance of the pixel electrode 124. Because each pixel 130 is composed of a plurality of RGB sub-pixels 120, a color performed by each pixel 130 is determined by a proportion of light transmittance of the plurality of RGB sub-pixels 120.

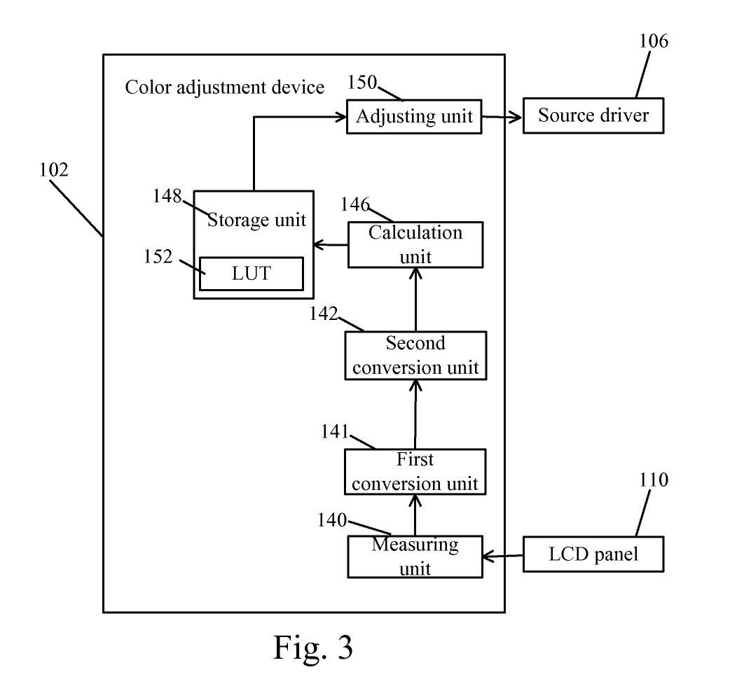

Referring to FIG. 3, FIG. 3 shows a block diagram of a color adjustment device 102. The color adjustment device 102 comprises a measuring unit 140, a first conversion unit 141, a second conversion unit 142, a calculation unit 146, a storage unit 148 and an adjusting unit 150. The measuring unit 140 measures multiple measured stimulus sets (WXₚ, WYₚ, WZₚ), (RX_{M}, RY_{M}, RZ_{M}), (GX_{L}, GY_{L}, GZ_{L}), and (BX_{N}, BY_{N}, BZ_{N}) performing as white, red, green and blue at all grayscales on the LCD panel 110, where p, M, L, N=0, 1, 2, . . . , 255. The first conversion unit 141, connected to the measuring unit 140, converts a predetermined white-measured stimulus set (WX₂₅₅, WY₂₅₅, WZ₂₅₅) from the multiple white measured stimulus sets (WXₚ, WYₚ, WZₚ) into a target luminance value WYₚ, a first target chromatic value W_{Xp}, and a second target chromatic value W_{Yp} of each white grayscale, where WYₚ=WY₂₅₅×(p/255)^{2.2}, W_{Xp}=WX₂₅₅/(WX₂₅₅+WY₂₅₅+WZ₂₅₅), W_{Yp}=WY₂₅₅/(WX₂₅₅+WY₂₅₅+WZ₂₅₅), p=0, 1, 2, . . . , 255. The second conversion unit 142, connected to the first conversion unit 141, converts the target luminance value WYₚ, the first target chromatic value W_{Xp}, and the second target chromatic value W_{Yp} at each white grayscale into a plurality of white target stimulus sets (WX′ₚ, WY′ₚ, WZ′ₚ), in which each white grayscale corresponds to a target stimulus set and each target stimulus set comprises three target stimulus values WX′ₚ, WY′ₚ, WZ′ₚ, where WY′ₚ=WY₂₅₅×(p/255)^{2.2}, WX′ₚ=W_{X255}×(WY′ₚ/W_{Y255}), WZ′ₚ=(1−W_{Xp}−W_{Yp})×(WY′ₚ/W_{Yp}), p=0, 1, 2, . . . , 255. The calculation unit 146, connected to the second conversion unit 142, calculates a set of corresponding ratios of three primary colors performing as white at each grayscale, based on each target stimulus set (WX′ₚ, WY′ₚ, WZ′ₚ) and multiple sets of tristimulus values (RX_{M}, RY_{M}, RZ_{M}), (GX_{L}, GY_{L}, GZ_{L}), and (BX_{N}, BY_{N}, BZ_{N}) of red, green and blue at all grayscales. A lookup table 152 stored in the storage unit 148 records all the ratios of three primary colors corresponding to the sets of three white target stimulus values produced by the calculation unit 146. The adjusting unit 150, connected to the storage unit 148, adjusts, before the LCD panel 110 showing a predetermined grayscale, the ratio of three primary colors of the predetermined white grayscale according to the ratio of three primary colors of the target stimulus set corresponding to the predetermined white grayscale, and then transmits the ratio of the three primary colors to the source driver 106.

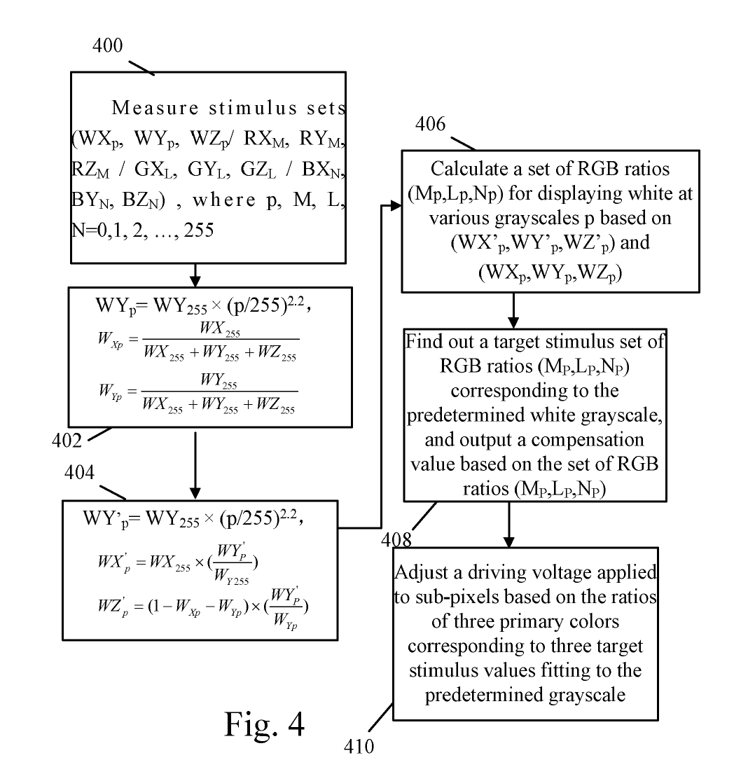

Referring to FIG. 4, FIG. 4 depicts a flow chart of a method for adjusting color according to the present invention. The method for adjusting color comprises following steps:

Step 400: measure a plurality of measured stimulus sets (WXₚ, WYₚ, WZₚ), (RX_{M}, RY_{M}, RZ_{M}), (GX_{L}, GY_{L}, GZ_{L}), and (BX_{N}, BY_{N}, BZ_{N}) performing as white, red, green and blue at all grayscales on the LCD panel 110, where p, M, L, N=0, 1, 2, . . . , 255.

Step 402: based on the predetermined white-measured stimulus set (WX₂₅₅, WY₂₅₅, WZ₂₅₅) of the multiple sets of white measured stimulus sets (WXₚ, WYₚ, WZₚ), determine the target luminance value WYₚ, the first target chromatic value W_{Xp}, and the second target chromatic value W_{Yp} of each white grayscale, where WYₚ=WY₂₅₅×(p/255)^{2.2}, W_{Xp}=WX₂₅₅/(WX₂₅₅+WY₂₅₅+WZ₂₅₅), W_{Yp}=WY₂₅₅/(WX₂₅₅+WY₂₅₅+WZ₂₅₅), p=0, 1, 2, . . . , 255.

Step 404: convert the target luminance value WYₚ, the first target chromatic value W_{Xp}, and the second target chromatic value W_{Yp} at each white grayscale into a plurality of white target stimulus sets, in which each white grayscale corresponds to a target stimulus set and each target stimulus set comprises three target stimulus values (WX′ₚ, WY′ₚ, WZ′ₚ), where WY′ₚ=WY₂₅₅×(p/255)^{2.2}, WX′ₚ=W_{X255}×(WY′ₚ/W_{Y255}), WZ′ₚ=(1−W_{Xp}−W_{Yp})×(WY′ₚ/W_{Yp}), p=0, 1, 2, . . . , 255.

Step 406: calculate a least-square solution of the white target stimulus set (WX′ₚ, WY′ₚ, WZ′ₚ) associated with the corresponding measured stimulus sets (WXₚ, WYₚ, WZₚ), in order to obtain the ratios (M,L,N) of three primary colors corresponding to the white at each grayscale. WX′ₚ refers to a target stimulus value X of white at the p grayscale, WY′ₚ to a target stimulus value Y of white at the p grayscale, and WZ′ₚ to a target stimulus value Z of white at the grayscale p. RX_{M} refers to a stimulus value X of red at the grayscale M, GX_{L} to a stimulus value X of green at the grayscale L, and BX_{N} to a stimulus value X of blue the grayscale N. So are the remaining parameters. Subsequently, integrate all the ratios of three primary colors (M,L,N) corresponding to each white target stimulus set (WX′ₚ, WY′ₚ, WZ′ₚ) into the lookup table 152.

Step 408: before the LCD panel 110 showing a predetermined grayscale, adjusts the ratio of three primary colors of the predetermined white grayscale according to the ratios of three primary colors of the target stimulus set corresponding to the predetermined white grayscale.

Step 410: adjust the driving voltages applied to the plurality of sub-pixels 120 of each pixel 130, based on the ratios of three primary colors of the target stimulus set corresponding to the predetermined white grayscale.

Referring to FIG. 3 to FIG. 5, at first the all pixels 130 of the LCD panel 110 performs as white at the original first grayscale (the grayscale 255), and the measuring unit 140 measures the pixels 130 performing as white at from the grayscale 0 to the grayscale 255 and obtains the measured stimulus sets (WXₚ, WYₚ, WZₚ/RX_{M}, RY_{M}, RZ_{M}/GX_{L}, GY_{L}, GZ_{L}/BX_{N}, BY_{N}, BZ_{N}) performing as white, red, green and blue at all grayscales on the LCD panel 110, where p, M, L, N=0, 1, 2, . . . , 255. (Step 400). In the present embodiment, the measured stimulus sets (WXₚ, WYₚ, WZₚ/RX_{M}, RY_{M}, RZ_{M}/GX_{L}, GY_{L}, GZ_{L}/BX_{N}, BY_{N}, BZ_{N}) are defined in the CIE1931XYZ color space.

After that, at the step 402, the first conversion unit 141 converts the white-measured stimulus set (WX₂₅₅, WY₂₅₅, WZ₂₅₅) corresponding to the white at the grayscale 255 into the target luminance value WYₚ, the first chromatic value W_{Xp} and the second chromatic value W_{Yp} of each grayscale according to Equation 1 as followed,

WYₚ=WY₂₅₅×(p/255)^{2.2},

W_{Xp}=WX₂₅₅/(WX₂₅₅+WY₂₅₅+WZ₂₅₅),

W_{Yp}=WY₂₅₅/(WX₂₅₅+WY₂₅₅+WZ₂₅₅),p=0,1,2, . . . ,255 Equation 1

In the present embodiment, the white at the grayscale 255 is substantially as the brightest pure white as the LCD panel 110 can perform. As a result, the target luminance value WYₚ corresponding to each grayscale changes in accordance with the grayscale index, and the target chromatic values W_{Xp} and W_{Yp} of each grayscale are identical to the chromatic values of the white at the grayscale 255.

At the step 404, the second conversion unit 142 converts the target luminance value WYₚ, the first target chromatic value W_{Xp} and the second target chromatic value W_{Yp} into the plurality of target stimulus sets by Equation 2, where each white grayscale corresponds to a target stimulus set, and each target stimulus set comprises three target stimulus values WX′ₚ, WY′ₚ, WZ′ₚ. The Equation 2 is as followed,

WY′ₚ=WY₂₅₅×(p/255)^{2.2},

WX′ₚ=WX₂₅₅×(WY′ₚ/W_{Y255}),

WZ′ₚ=(1−W_{Xp}−W_{Yp})×(WY′ₚ/Wyₚ),p=0,1,2, . . . ,255 Equation 2

The second conversion unit 142 converts the target luminance value WYₚ, the first target chromatic value W_{Xp} and the second target chromatic value W_{Yp} of each white grayscale into the white target stimulus sets (WX′ₚ, WY′ₚ, WZ′ₚ) according to the CIE1931XYZ color space.

At the step 406, the calculation unit 146 calculates the least square solution of the white target stimulus set (WX′ₚ, WY′ₚ, WZ′ₚ) associated with the corresponding measured stimulus sets (WXₚ, WYₚ, WZₚ), in order to obtain the RGB ratios (M_{P}, L_{P}, N_{P}) corresponding to the white at each grayscale. Ideally, the calculation unit 146 calculates the multiple sets of the RGB ratios (M_{P}, L_{P}, N_{P}), and each set of RGB ratios (M_{P}, L_{P}, N_{P}) corresponds to one of the white target stimulus set (WX′_{P}, WY′_{P}, WZ′_{P}). That is, WX′_{P}=RX_{M}+GX_{L}+BX_{N}, WY′_{P}=RY_{M}+GY_{L}+BY_{N}, WZ'_{P}=RZ_{M}+GZ_{L}+BZ_{N}, where RX_{M} represents, when the white at the grayscale P to be performed, red stays at the stimulus value X of the M grayscale, GX_{L} indicates green at the stimulus value X of the L grayscale, and BX_{N} indicates blue at the stimulus value X of the N grayscale. So are the remaining parameters. In fact, the set of RGB ratios (M_{P}, L_{P}, N_{P}) meeting the above-mentioned conditions does not necessarily exist. Accordingly, the set of RGB ratios (M_{P}, L_{P}, N_{P}) which the calculation unit 146 actually obtains is an approximate solution to the white target stimulus set (WX′ₚ, WY′ₚ, WZ′ₚ).

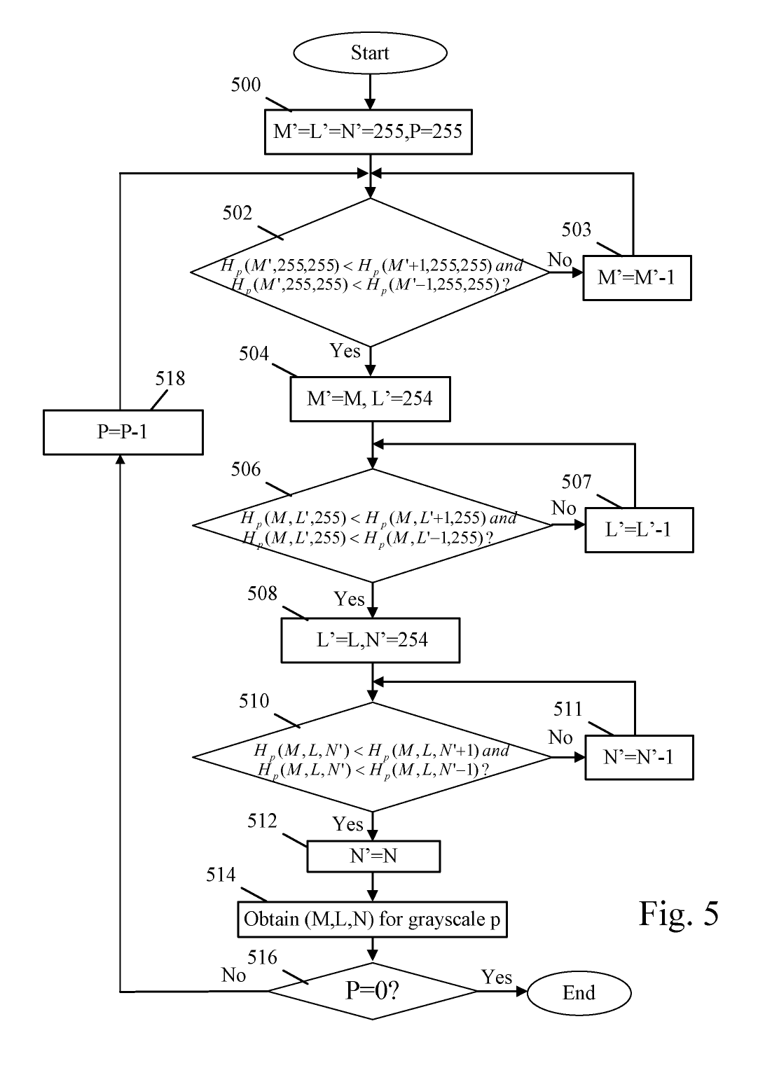

Referring to FIG. 5, FIG. 5 depicts a flow chart of the method, by which at the step 406 in FIG. 4, the calculation unit calculates the least square solution of the white target stimulus set (WX′ₚ, WY′ₚ, WZ′ₚ) associated with the corresponding measured stimulus sets (WXₚ, WYₚ, WZₚ). At the step 406, the calculation unit 146 calculates a set of RGB ratios (M_{P},L_{P},N_{P}) for each grayscale p, according to H_{P}(M,L,N)=\sqrt{(WX′ₚ−WXₚ)²+(WY′ₚ−WYₚ)²+(WZ′ₚ−WZₚ)²}˜0. All steps in FIG. 5 are as followed.

Step 500: calculate the ratios of three primary colors (M_{P},L_{P},N_{P}) corresponding to the grayscale 255, where M′=L′=N′=255, P=255.

Step 502: judge if Hₚ(M′,255,255)<Hₚ(M′+1,255,255) and Hₚ(M′,255,255)<Hₚ(M′−1,255,255) ?If so, then go to the step 504; if not, go to the step 503.

Step 503: replace M′-1 for the original M′, and continue the step 502.

Step 504: set the obtained M′ as a stimulus value M, and set L′ as 254.

Step 506: judge if Hₚ(M, L′,255)<Hₚ(M, L′+1,255) and Hₚ(M, L′,255)<Hₚ(M, L′−1,255) ?If so, then go to the step 508; if not, go to the step 507.

Step 507: replace L′−1 for the original L′, and continue the step 506.

Step 508: set the obtained L′ as a stimulus value L, and set N′ as 254.

Step 510: judge if Hₚ(M,L,N′)<Hₚ(M,L,N′+1) and Hₚ(M,L,N′)<Hₚ(M,L,N′−1) ?If so, then go to the step 512; if not, go to the step 511.

Step 511: replace N′−1 for the original N′, and continue the step 510.

Step 512: set the obtained N′ as a stimulus value N.

Step 514: store the ratios of three primary colors corresponding to the grayscale p (M_{P},L_{P},N_{P})=(M,L,N) into a lookup table 152, which stored in the storage unit 148.

Step 516: if p=0, which means the corresponding RGB ratios (M_{P},L_{P},N_{P}) of all grayscales are obtained, then end. If not, go to the step 518, which continues the step 502 after replacing P−1 for the original P.

Referring to FIG. 4, when the LCD panel is going to display an image, the adjusting unit 150, connected to the source driver 106, after receiving a predetermined white grayscale, finds out a target stimulus set of RGB ratios (M_{P},L_{P},N_{P}) corresponding to the predetermined white grayscale from the lookup table 152, and, based on the set of RGB ratios (M_{P},L_{P},N_{P}), outputs a compensation value to the source driver 106 (Step 408).

At the step 410, the source driver 106, based on the target stimulus set of RGB ratios corresponding to the predetermined white grayscale, adjusts driving voltages applied to the plurality of sub-pixels 120 of each pixel 130.

When the display device 100 is working and the pixel 130 is performing as white at 80 grayscale, the adjusting unit 150 receives a signal of grayscale 80 and then finds out a set of RGB ratios (M₈₀,L₈₀,N₈₀) corresponding to a white target stimulus set (WX′₈₀, WY′₈₀, WZ′₈₀) out of the lookup table 152. According to the set of RGB ratios (M₈₀, L₈₀, N₈₀), the adjusting unit 150 outputs a compensation value. As a result, the RGB sub-pixels 120 of the pixel 130 automatically adjusts the RGB ratios (M₈₀, L₈₀, N₈₀) and performs as white, whose chromatic value is the same as that of the grayscale 255.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A method of adjusting color, characterized in that: the method comprises:
(a) measuring a plurality of measured sets (WXₚ, WYₚ, WZₚ), (RX_{M}, RY_{M}, RZ_{M}), (GX_{L}, GY_{L}, GZ_{L}), and (BX_{N}, BY_{N}, BZ_{N}) performing respectively as white, red, green and blue at all grayscales on a LCD panel, where p, M, L, N=0, 1, 2, . . . , 255;
(b) converting a predetermined white-measured set (WX₂₅₅, WY₂₅₅, WZ₂₅₅) from the plurality of measured stimulus sets (WXₚ, WYₚ, WZₚ) into a plurality of target chromatic sets comprising a target luminance value WYₚ, a first target chromatic value W_{Xp}, and a second target chromatic value W_{Yp} of each of white grayscales, where WYₚ=WY₂₅₅×(p/255)^{2.2}, W_{Xp}=WX₂₅₅/(WX₂₅₅+WY₂₅₅+WZ₂₅₅), W_{Yp}=WY₂₅₅/(WX₂₅₅+WY₂₅₅+WZ₂₅₅), p=0, 1, 2, . . . , 255;
(c) converting each of the target chromatic sets into a plurality of white target stimulus sets, each white grayscale corresponding to a target stimulus set and each target stimulus set comprising three target stimulus values WX′ₚ, WY′ₚ, WZ′ₚ, where WY′ₚ=WY₂₅₅×(p/255)^{2.2}, WX′ₚ=W_{X255}×(WY′ₚ/W_{Y255}), WZ′ₚ=(1−W_{Xp}−W_{Yp})×(WY′ₚ/W_{Yp}), p=0, 1, 2, . . . , 255; and
(d) calculating each set of RGB ratios for each white grayscale, based on the corresponding white target stimulus set (WX′ₚ, WY′ₚ, WZ′ₚ) and the corresponding measured stimulus set (WXₚ, WYₚ, WZₚ) at the corresponding grayscale.

2. The method of claim 1, characterized in that: the method further comprises:
before the LCD panel showing a predetermined white grayscale, adjusting RGB ratios of a predetermined white grayscale according to the RGB ratios of the target stimulus set at the predetermined white grayscale.

3. The method of claim 2, the LCD panel comprising a plurality of pixels, each pixel comprising a plurality of sub-pixels for displaying three primary colors, red, green and blue, characterized in that: the method further comprises: based on the RGB ratios of the target stimulus set at the predetermined white grayscale, adjusting driving voltages applied to the plurality of sub-pixels of each pixel.

4. The method of claim 1, characterized in that: the step (d) further comprises: calculating a least-square solution of the target stimulus sets (WX′ₚ, WY′ₚ, WZ′ₚ) of each white target stimulus set associated with the corresponding measured stimulus sets (WXₚ, WYₚ, WZₚ), in order to obtain the RGB ratios corresponding to each white grayscale.

5. A color adjusting device, characterized in that: the color adjusting device comprises:
a measuring unit for measuring a measured stimulus set (WXₚ, WYₚ, WZₚ/RX_{M}, RY_{M}, RZ_{M}/GX_{L}, GY_{L}, GZ_{L}/BX_{N}, BY_{N}, BZ_{N}) performing as white, red, green and blue at all grayscales on a LCD panel, where p, M, L, N=0, 1, 2, . . . , 255;
a first conversion unit, connected to the measuring unit, for converting a predetermined white-measured stimulus set (WX₂₅₅, WY₂₅₅, WZ₂₅₅) of the plurality of measured stimulus sets (WXₚ, WYₚ, WZₚ) into a target chromatic set comprising a target luminance value WYₚ, a first target chromatic value W_{Xp}, and a second target chromatic value W_{Yp} of each of white grayscales, where WYₚ=WY₂₅₅×(p/255)^{2.2}, Wxₚ=WX₂₅₅/(WX₂₅₅+WY₂₅₅+WZ₂₅₅), W_{Yp}=WY₂₅₅/(WX₂₅₅+WY₂₅₅+WZ₂₅₅), p=0, 1, 2, . . . , 255;
a second conversion unit, connected to the first conversion unit, for converting the target chromatic set of each white grayscale into a plurality of white target stimulus sets (WX′ₚ, WY′ₚ, WZ′ₚ), each white grayscale corresponding to a target stimulus set and each target stimulus set comprising three target stimulus values WX′ₚ, WY′ₚ, WZ′ₚ, where WY′ₚ=WY₂₅₅×(p/255)^{2.2}, WX′ₚ=W_{X255}×(WY′ₚ/W_{Y255}), WZ′ₚ=(1−W_{Xp}−W_{Yp})×(WY′ₚ/W_{Yp}), p=0, 1, 2, . . . , 255; and
a calculation unit, connected to the second conversion unit, for calculating each set of RGB ratios for each white grayscale, based on the corresponding white target stimulus set (WX′ₚ, WY′ₚ, WZ′ₚ) and the measured stimulus set (WXₚ, WYₚ, WZₚ) of the corresponding grayscale.

6. The color adjusting device of claim 5, characterized in that: the color adjusting device further comprises a storage unit for storing as a lookup table of all the RGB ratios corresponding to the white target stimulus sets produced by the calculation unit.

7. The color adjusting device of claim 6, characterized in that: the color adjusting device further comprises an adjusting unit, connected to the storage unit, for adjusting, before the LCD panel showing a predetermined white grayscale, the RGB ratios of the predetermined white grayscale according to the RGB ratios of the target stimulus set at the predetermined white grayscale.

8. The color adjusting device of claim 5, characterized in that: the calculation unit calculates a least-square solution of the stimulus sets (WX′ₚ, WY′ₚ, WZ′ₚ) of each white target stimulus set associated with the corresponding measured stimulus sets (WXₚ, WYₚ, WZₚ), in order to obtain the RGB ratios corresponding to each white grayscale.

9. A display comprising a liquid crystal display (LCD) panel, the LCD panel comprising a plurality of pixels for displaying an image, each pixel comprising a plurality of sub-pixels, characterized in that: the display further comprises a color adjustment device, the color adjustment device comprising:
a measuring unit for measuring a measured stimulus set (WXₚ, WYₚ, WZₚ/RX_{M}, RY_{M}, RZ_{M}/GX_{L}, GY_{L}, GZ_{L}/BX_{N}, BY_{N}, BZ_{N}) performing as white, red, green and blue at all grayscales on a LCD panel, where p, M, L, N=0, 1, 2, . . . , 255;
a first conversion unit, connected to the measuring unit, for converting a predetermined white-measured stimulus set (WX₂₅₅, WY₂₅₅, WZ₂₅₅) of the plurality of measured stimulus sets (WXₚ, WYₚ, WZₚ) into a target chromatic set comprising a target luminance value WYₚ, a first target chromatic value W_{Xp}, and a second target chromatic value W_{Yp} of each of white grayscales, where WYₚ=WY₂₅₅×(p/255)^{2.2}, W_{Xp}−WX₂₅₅/(WX₂₅₅+WY₂₅₅+WZ₂₅₅), W_{Yp}=WY₂₅₅/(WX₂₅₅+WY₂₅₅+WZ₂₅₅), p=0, 1, 2, . . . , 255;
a second conversion unit, connected to the first conversion unit, for converting the target chromatic set of each white grayscale into a plurality of white target stimulus sets (WX′ₚ, WY′ₚ, WZ′ₚ), each white grayscale corresponding to a target stimulus set and each target stimulus set comprising three target stimulus values WX′ₚ, WY′ₚ, WZ′ₚ, where WY′ₚ=WY₂₅₅×(p/255)^{2.2}, WX′ₚ=W_{X255}×(WY′ₚ/W_{Y255}), WZ′ₚ=(1−W_{Xp}−W_{Yp})×(WY′ₚ/W_{Yp}), p=0, 1, 2, . . . , 255; and
a calculation unit, connected to the second conversion unit, for calculating each set of RGB ratios for each white grayscale, based on the corresponding white target stimulus set (WX′ₚ, WY′ₚ, WZ′ₚ) and the measured stimulus set (WXₚ, WYₚ, WZₚ) of the corresponding grayscale.

10. The display of claim 9, characterized in that: the color adjusting device further comprises a storage unit for storing as a lookup table of all the RGB ratios corresponding to the white target stimulus sets produced by the calculation unit.

11. The display of claim 10, characterized in that: the color adjusting device further comprises an adjusting unit, connected to the storage unit, for adjusting, before the LCD panel showing a predetermined white grayscale, the RGB ratios of the predetermined white grayscale according to the RGB ratios of the target stimulus set at the predetermined white grayscale.

12. The display of claim 11, characterized in that: the display further comprises a driving unit coupled to the adjusting unit for adjusting driving voltage applied to the plurality of sub-pixels of each pixel according to the RGB ratios corresponding to the set of three target stimulus values at the predetermined grayscale.

13. The display of claim 9, characterized in that: the calculation unit calculates a least-square solution of the white target stimulus set (WX′ₚ, WY′ₚ, WZ′ₚ) associated with the corresponding measured stimulus sets (WXₚ, WYₚ, WZₚ), in order to obtain the RGB ratios corresponding to each white grayscale.
